(19) United States
(12) Patent Application Publication
(10) Pub. No.: US 2004/0179243 A1
(43) Pub. Date: Sep. 16, 2004

(54) Simplified image sensor module

(76) Inventors: Jackson Hsieh, Hsinchu Hsien (TW); Jichen Wu, Hsinchu Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/386,082

(22) Filed: Mar. 10, 2003

(51) Int. Cl. H04N 1/04; H04N 1/46

(52) U.S. Cl. 358/474; 358/505

(57) ABSTRACT

A simplified image sensor module includes a substrate, a photosensitive chip, a plurality of wires, and transparent glue. The substrate has an upper surface formed with a plurality of first connection points, and a lower surface formed with a plurality of second connection points. The photosensitive chip has a plurality of bonding pads and is mounted to the upper surface of the substrate. The wires electrically connect the bonding pads of the photosensitive chip to the first connection points of the substrate, respectively. The transparent glue is arranged on the upper surface of the substrate to encapsulate the photosensitive chip and is formed with a convex portion corresponding to the photosensitive chip. The photosensitive chip may receive focused optical signals focused by the convex portion of the transparent glue.

### BACKGROUND OF THE INVENTION

1. Field of the Invention

The invention relates to a simplified image sensor module, and in particular to an image sensor module having a simplified structure that may be manufactured easily and in low cost.

2. Description of the Related Art

Referring to FIG. 1, a conventional image sensor module includes a lens holder 10, a lens barrel 20, and an image sensor 30. The lens holder 10 has a top face 12, a bottom face 14 and a chamber 16 penetrating through the lens holder 10 from the top face 12 to the bottom face 14. The chamber 16 of the lens holder 10 is formed with an internal thread 18. The lens barrel 20 is formed with an external thread 22, inserted into the chamber 16 from the top face 12 of the lens holder 10, and screwed to the internal thread 18 of the lens holder 10. The lens barrel 20 is also formed with a transparent region 24. An aspheric lens 26 is arranged within the chamber 16 and under the transparent region 24. An infrared filter 28 is also arranged within the chamber and under the aspheric lens 26. The image sensor 30 has a first face 32 and a second face 34. The first face 32 is provided with a transparent layer 36. The transparent layer 36 of the image sensor 30 is adhered to the bottom face 14 of the lens holder 10. The focal length between the aspheric lens 26 of the lens barrel 20 and the transparent layer 36 of the image sensor 30 may be controlled by adjusting the screwed length between the lens barrel 20 and the lens holder 10.

However, the above-mentioned image sensor module has the following drawbacks.

1. The manufacturing processes are complicated because the image sensor 30 has to be packaged and then combined with the lens holder 10 and the lens barrel 20 to form a module so that the image sensor 30 may receive optical signals focused by the aspheric lens 26. Therefore, the structure of the image sensor module is complicated and the overall volume thereof is large.

2. Since the transparent layer 36 is adhered to the bottom face 14 of the lens holder 10 by an adhesive, the adhesive may contaminate the surface of the transparent layer 36 and the image sensor cannot receive the optical signals normally.

3. When the module is assembled, the transparent layer 36 has to be precisely aligned with the aspheric lens 26 and then adhered to the aspheric lens 26. After the adhering process, if the transparent layer 36 and the aspheric lens 26 are not aligned properly, the overall module cannot be disassembled and reassembled, and the module has to be treated as a waste material.

### SUMMARY OF THE INVENTION

An object of the invention is to provide a simplified image sensor module having a simplified structure that may be manufactured easily and in low cost.

Another object of the invention is to provide a simplified image sensor module having a miniaturized volume.

To achieve the above-mentioned objects, the invention provides a simplified image sensor module including a substrate, a photosensitive chip, a plurality of wires, and transparent glue. The substrate has an upper surface formed with a plurality of first connection points, and a lower surface formed with a plurality of second connection points. The photosensitive chip has a plurality of bonding pads and is mounted to the upper surface of the substrate. The wires electrically connect the bonding pads of the photosensitive chip to the first connection points of the substrate, respectively. The transparent glue is arranged on the upper surface of the substrate to encapsulate the photosensitive chip and is formed with a convex portion corresponding to the photosensitive chip.

Therefore, the photosensitive chip may receive focused optical signals focused by the convex portion of the transparent glue.

### BRIEF DESCRIPTION OF THE DRAWINGS

FIG. 1 is a cross-sectional view showing a conventional image sensor module.

FIG. 2 shows a simplified image sensor module according to a first embodiment of the invention.

FIG. 3 shows a simplified image sensor module according to a second embodiment of the invention.

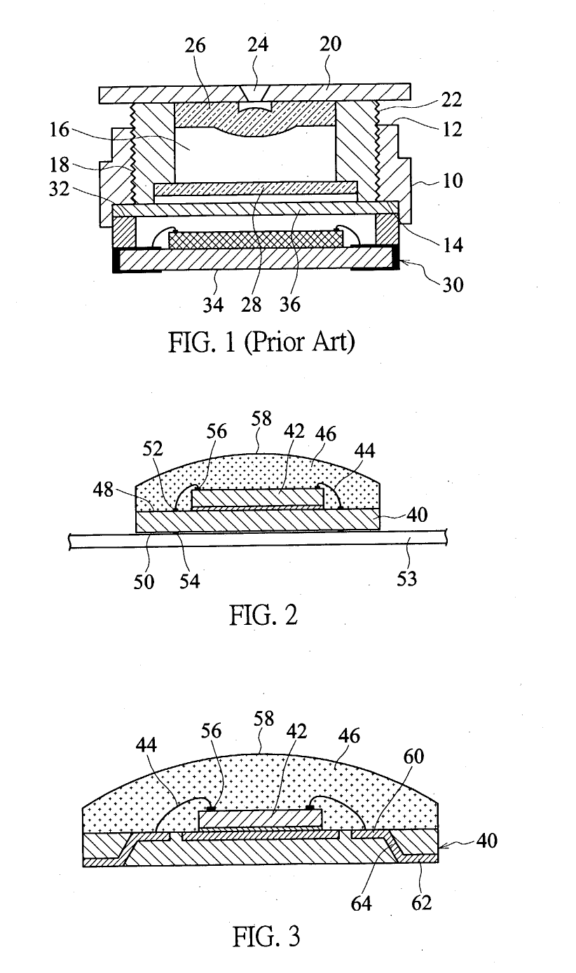

### DETAILED DESCRIPTION OF THE INVENTION

Referring to FIG. 2, a simplified image sensor module according to a first embodiment of the invention includes a substrate 40, a photosensitive chip 42, a plurality of wires 44 and transparent glue 46.

The substrate 40 has an upper surface 48 formed with a plurality of first connection points 52, and a lower surface 50 formed with a plurality of second connection points 54 for being electrically connected to a printed circuit board 53.

The photosensitive chip 42 has a plurality of bonding pads 56 and is mounted to the upper surface 48 of the substrate 40.

The wires 44 electrically connect the bonding pads 56 of the photosensitive chip 42 to the first connection points 52 of the substrate 40 so that signals from the photosensitive chip 42 may be transferred to the substrate 40.

The transparent glue 46 is applied to or placed on the upper surface 48 of the substrate 40 to cover and encapsulate the photosensitive chip 42 and is formed with an arc-shaped convex portion 58 corresponding to the photosensitive chip 42. Therefore, the photosensitive chip 42 may receive focused optical signals focused by the convex portion 58.

After the photosensitive chip 42 is packaged, it can receive the focused optical signals by the provision of the convex portion 58 of the transparent glue 46. Therefore, the image sensor of the invention does not need to use another lens module, the product size can be effectively reduced, the manufacturing processes may be simplified, and the manufacturing cost may be effectively lowered.

Referring to FIG. 3, a simplified image sensor module according to a second embodiment of the invention includes a substrate 40, a photosensitive chip 42, a plurality of wires 44 and transparent glue 46.

The substrate 40 is composed of a plurality of metal sheets arranged in a matrix. Each metal sheet has a first board 60, a second board 62 and a third board 64 connecting the first board 60 to the second board 62. The metal sheets are encapsulated by an industrial plastic material by way of injection molding or die pressing with the upper surfaces of the first boards 60 and the lower surfaces of the second boards 62 exposed from the industrial plastic to form the substrate 40.

The photosensitive chip 42 is mounted to the substrate 40 and the wires 44 electrically connect bonding pads 56 of the photosensitive chip 42 to the upper surfaces of the first boards 60, respectively.

The transparent glue 46 is placed on or applied to the upper surface 48 of the substrate 40 to cover and encapsulate the photosensitive chip 42, and is formed with an arc-shaped convex portion 58 corresponding to the photosensitive chip 42. Therefore, the photosensitive chip 42 may receive focused optical signals focused by the convex portion 58.

After the photosensitive chip 42 is packaged, it can receive the focused optical signals by the provision of the convex portion 58 of the transparent glue 46. Therefore, the image sensor of the invention does not need to use another lens module, the product size can be effectively reduced, the manufacturing processes may be simplified, and the manufacturing cost may be effectively lowered.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A simplified image sensor module, comprising:
a substrate having an upper surface formed with a plurality of first connection points, and a lower surface formed with a plurality of second connection points;
a photosensitive chip, which has a plurality of bonding pads and is mounted to the upper surface of the substrate;
a plurality of wires for electrically connecting the bonding pads of the photosensitive chip to the first connection points of the substrate, respectively; and
transparent glue arranged on the upper surface of the substrate to encapsulate the photosensitive chip, the transparent glue being formed with a convex portion corresponding to the photosensitive chip.

2. The image sensor module according to claim 1, wherein the convex portion of the transparent glue has an arc-shaped structure.

3. The image sensor module according to claim 1, wherein the substrate is composed of a plurality of metal sheets, which is encapsulated by an industrial plastic material.

4. The image sensor module according to claim 3, wherein each of the plurality of metal sheets has a first board, a second board and a third board connecting the first board to the second board.

5. The image sensor module according to claim 3, wherein the plurality of metal sheets is encapsulated by the industrial plastic by way of injection molding or die pressing.
